(19) United States
(12) Patent Application Publication
(10) Pub. No.: US 2025/0316720 A1
(43) Pub. Date: Oct. 9, 2025

(54) MICROFABRICATED POROUS TRANSPORT LAYER

(71) Applicant: Payam BOZORGI, Santa Barbara, CA (US)

(72) Inventor: Payam BOZORGI, Santa Barbara, CA (US)

(73) Assignee: Payam BOZORGI, Santa Barbara, CA (US)

(21) Appl. No.: 19/171,144

(22) Filed: Apr. 4, 2025

Related U.S. Application Data
(60) Provisional application No. 63/574,976, filed on Apr. 5, 2024.

(51) Int. Cl. H01M 8/0232; C25B 1/04; C25B 9/19; C25B 13/05; H01M 8/0245; H01M 8/0263; H01M 8/10

(52) U.S. Cl. CPC H01M 8/0232; C25B 1/04; C25B 9/19; C25B 13/05; H01M 8/0245; H01M 8/0263; H01M 2008/1095

(57) ABSTRACT

A novel microfabricated Titanium-based porous transport layer (PTL) is described, for use in a hydrogen electrolytic fuel cell. The novel structure may have improved properties and enable improved utilization of the catalyst layer, which is a key metric for hydrogen fuel systems. The structure is intended to be used with a polymeric membrane and is disposed directly adjacent to the catalytic layer on the cathode side of the structure. The improved performance result from is three dimensions microfabricated design, which allows a large number of tightly controlled through hole structure, which increases the surface area available for the electrolytic reaction.

### CROSS REFERENCE TO RELATED APPLICATIONS

The non-Provisional U.S. Patent Application claims priority to U.S. Provisional Application Ser. No. 63/574,976, filed Apr. 5, 2024. This prior application is incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

This invention relates to hydrogen fuel cell technology.

Electrochemical apparatus with stacked components as polymer electrolyte water electrolysis (PEWE) and Polymer electrolyte fuel cell (PEFC) are considered as Electrochemical devices that splitting water into the gaseous Products oxygen and hydrogen or producing power from Hydrogen and oxygen containing gases. The electrochemical Components are based on a protonic conducting polymer membrane, anodic and cathodic catalyst layers as well as porous transport layers (PTL) allowing the fluids/gases to circulate towards the polymer membrane.

The PTL is an essential component of the polymer electrolyte membrane water electrolyzer (PEMWE), responsible for a better utilization of the catalyst layer (CL). The PTL allows transporting the reactant water to the anode and cathode CLs, removing produced oxygen gas and providing good electrical conductivity for effective electron conduction. This invention is to introduce a new concept of a 3D PTL with variable microstructures to ensure stable electrochemical performance of PEMWEs.

The current state of the art technology to build PTL is to use sintered titanium powdered to build a mesh-felt structure with thickness of 250 um.

Accordingly, current hydrogen fuel cell technology has a number of safety, performance, manufacturing in mass production, cost and reliability issues.

### SUMMARY

The present application discloses a three dimensional, microfabricated titanium porous transport layer (3D-Ti-PTL) having significantly improved efficiency, cost, size and robustness. The architecture is based on the use of a titanium substrate and photolithographic processing to define small, tightly controlled features. The design makes use of a well defined water channels disposed on both sides of the substrate, which overlap at certain points, forming through holes in the Ti substrate at well defined locations.

Thus, an object of this invention is to provide an architecture for a 3D Titanium based PTL with features described below. This structure is referred to herein as a Titanium based 3D Micro Porous Transport Layer (3D-Ti-PTL). The 3D-Ti-PTL may have a permeability for gaseous and liquid substances in an electrochemical cell. The 3D-Ti-PTL may be made of titanium sheets. The thickness of the micro 3D-Ti-PTL may be anywhere from 25 um to 250 um. The proposed 3D-Ti-PTL has significant less porosity compared to other existing state-of-art PTLs, yet outperforms other 3D-Ti-PTL technologies in the market. Details as to the design and functionality are discussed below.

The proposed 3D-Ti-PTL may have less porosity compared to other existing state-of-art PTLs, as a result, it may provide less ohmic electric resistance for electron to conduct in through plane direction. However, this same feature may also provide better performance for the cell because of the reduction of the lower high-frequency resistance (HFR).

HFR is the value obtained at high frequencies (usually >1 kHz) and mainly represents the membrane ionic resistance. HFR is a good indicator of the water content of the membrane due to its first component dependency on water. It is commonly used for the state-of-health monitoring of a fuel cell stack and is a critical indicator for dry out (i.e., low water content of the polymer electrolyte) or flooding (i.e., too much water inside fuel cell electrodes) conditions inside the fuel cell stack. HFR is also an important indicator of certain types of degradation in the fuel cell. It affects the performance of the fuel cell, especially at high current densities as it is closely related to the ohmic voltage loss (ΔVohm=I×R).

The advantage of the 3D-Ti-PTL is that although it may have less porosity than other existing state-of-art PTLs, the 3D-Ti-PTL provides much higher mechanical rigidity. This means, it enables a significant reduction in the membrane layer thickness (reduce ohmic resistance of membrane layer) or assist to increase the rigidity of the membrane layer. This may allow it to operate at a higher pressure differential condition. This may be extremely important for manufacturing and assembling of the PEMWE and the corresponding fuel cells. It may also reduce the cost of manufacturing while increasing the fuel cell overall performance.

The interfacial contact resistance (ICR) between proposed 3D Ti-PTL and the coated catalysis in anode can be reduced by applying precious group metal (PGM) coatings on the 3D-Ti-PTL surfaces. Candidate materials may include gold (Au), Platinum (Pt) palladium (Pd) or other PGMs.

Accordingly, an object of this invention is to provide an architecture for an improved Polymer Electrolyte Membrane Water Electroysis (PEMWE) fuel cell renewable energy source.

Another object of this invention is to provide an architecture for a PEMWE which is more robust, more efficient and less expensive than the state-of-the-art fuel cell.

Another object of this invention is to provide an architecture which is dimensionally smaller than the state-of-the-art fuel cell which providing the same or more output as a state-of-the-art fuel cell.

The focus of this architecture is on the porous transport layer (PTL),

The architecture proposed here replaces the porous PTL using sintered titanium powder into a mesh-felt structure having a thickness of 250 um with a substantially thinner, 3D microfabricated Porous Titanium structure, having thickness of between about 25 to about 250 um.

### BRIEF DESCRIPTION OF THE DRAWINGS

Various exemplary details are described with reference to the following figures, wherein:

FIG. 1 illustrates a hydrogen fuel cell according to present day practice;

FIG. 2 is a perspective view of a portion of view of the anode side (which is coupled to the catalyst layer coated on the anode side) of a microfabricated 3D Ti-PTL);

FIG. 3 shows a wider field view of the anode side of a microfabricated 3D Ti-PTL;

FIG. 4 is a simplified plan view of the anode side of the PTL; and

FIG. 5 is a simplified plan view of the Bipolar side of the 3D Ti-PTL (which is coupled to the bipolar water low reservoir).

It should be understood that the drawings are not necessarily to scale, and that like numbers may refer to like features.

### DETAILED DESCRIPTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

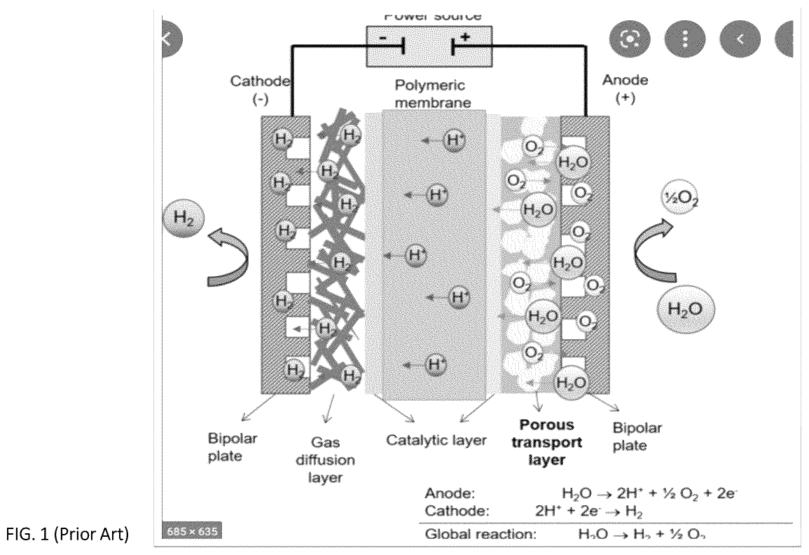

FIG. 1 illustrates a prior art fuel cell design. Although FIG. 1 is prior art, it is described here in some detail in order to provide background and context to the present inventions, and to introduce some terms that are used by those skilled in the art. The PTL is an essential component of the polymer electrolyte membrane water electrolyzer (PEMWE), responsible for a better utilization of the catalyst layer (CL). The PTL allows transporting the reactant water to the anode and cathode CLs, removing produced oxygen gas and providing good electrical conductivity for effective electron conduction.

As the interface between the CL and the PTL accounts for ohmic, kinetic, and mass transport overpotentials, the importance of the PTL/CL interface is emphasized. Efforts are also made to analyze the effects of PTL properties on performance from various studies conducted by different research groups.

To reduce the capital and operational cost of PEM water electrolysis, the porous transport layer (PTL) has been investigated intensively in the recent past. A PTL, sandwiched between a catalyst layer and a flow field, is responsible to transport water and oxygen on the anode side as well as hydrogen on the cathode side. In addition to the role of multiphase fluid transportation, PTL also acts as a current collector. A comprehensive insight into PTL materials, structural properties, and their function is strongly required to enhance performance and reduce the cost of PEMWE system.

The important factors in PTLs include structural properties, surface modifications, and their impact on enhancing electrochemical performance and durability. In particular, the effect of pore size, porosity, pore gradient, thickness, and pretreatment on ohmic, mass transport, activation overpotential.

In the discussion to follow, the following acronyms are defined with reference to FIG. 1. A “PTL” refers to a porous trans
CL catalytic layer
PEFC Polymer electrolyte fuel cell
PEWE Polymer electrolyte water electrolysis
PGM Precious group metal
ICR interfacial contact resistance

The term “bipolar plates” refers to a metal structure that transports the electrolytically created ions away from the polymeric membrane. Two bipolar plates are shown in FIG. 1. The anode side on the left hand portion conducts the protons (H+) to the cathode side and the bipolar plate on the right hand side conducts the O2 molecules to the anode side. The term “3D-Ti-PTL” should be understood to mean a PTL material comprising a preponderance of titanium, or titanium alloyed with another element. The Ti alloys may include aluminum, vanadium, carbon, nitrogen, oxygen, hydrogen, iron or ytterbium. This list is exemplary only, and is not intended to be an exhaustive list of all of the titanium alloy options. The PTL material is compatible with lithographic microfabrication techniques including for example, chemical or plasma etching through a photolithographic mask or a laser based microfabrication techniques, such as ablation.

As mentioned previously, electrolysis of water into its constituent hydrogen and oxygen can be improved by a large active surface area that allows for efficient use of all the PTL material. As mentioned, to achieve higher surface area of the PTL, holes and channels may be formed lithographically in the material, resulting in very small features forming the porous structure. The features may have tightly controlled, highly reproducible dimensions.

FIG. 1 shows a polymer electrolyte membrane water electrolyzer (PEMWE). It includes an electrochemical apparatus with stacked components as polymer electrolyte water electrolysis (PEWE) and Polymer electrolyte fuel cell (PEFC). These are considered as Electrochemical devices that splitting water into the gaseous Products oxygen and hydrogen or producing power from Hydrogen and oxygen containing gases. The electrochemical components are based on a protonic conducting polymer membrane, anodic and cathodic catalyst layers as well as porous transport layers (PTL) allowing the fluids/gases to circulate towards the polymer membrane.

The PTL is an essential component of the polymer electrolyte membrane water electrolyzer (PEMWE), responsible for a better utilization of the catalyst layer (CL). The PTL allows transporting the reactant water to the anode and cathode CLs, removing produced oxygen gas and providing good electrical conductivity for effective electron conduction. This invention is to introduce a new concept of a 3D PTL with variable microstructures to ensure stable electrochemical performance of PEMWEs.

In the architecture described below, a titanium-based microfabricated structure is substituted for the mesh or other porous structure described with respect to FIG. 1.

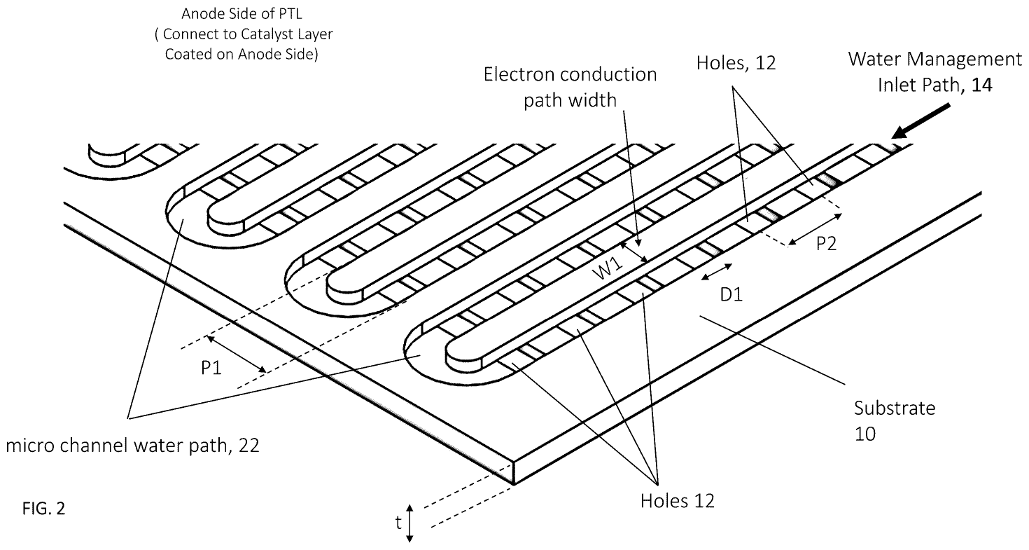

FIGS. 2-5 illustrate aspects of the novel 3D-Ti-PTL

FIG. 2 is a perspective view of a portion of the anode side of the 3D-Ti-PTL (the side which is coupled to the catalyst layer coated on the anode side) of a microfabricated 3D-Ti-PTL. A number of microfabricated structures are depicted in FIG. 2. The material forming the structure shown in FIG. 2 may preferably be a Titanium substrate 10, which as a metal provides a conduction path for electrons as indicated in FIG. 2. The Ti substrate 10 thickness t may be between about 25 microns to 250 microns. The electron conduction path W1 may be about 25 to about 250 micron. The substrate 10 has two generally parallel faces, a first “anode” side and a second, obverse “bipolar” side. The “anode” side is immediately adjacent to the catalyst layer whereas the “bipolar” side may be immediately adjacent to the bipolar plate (refer to FIG. 1).

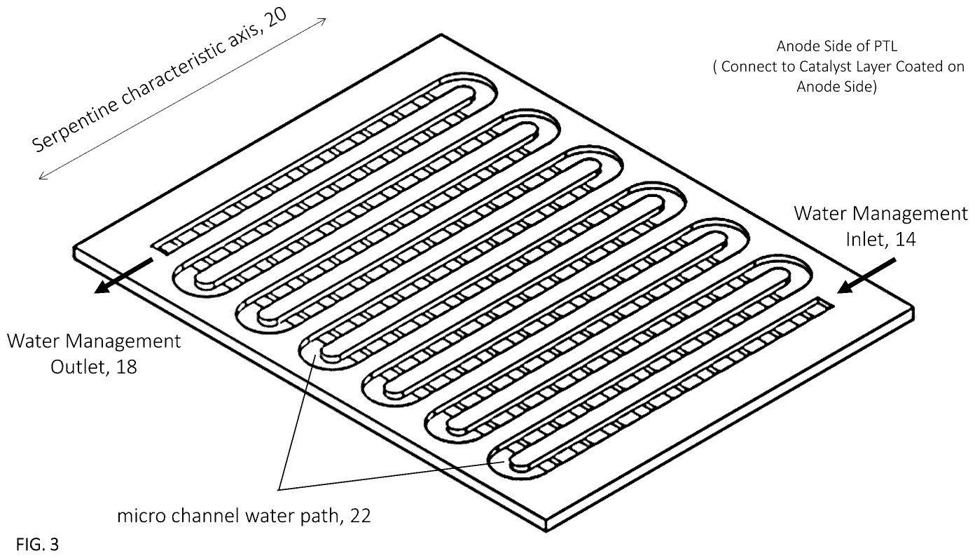

A water management inlet path 14 may be a channel formed lithographically by, for example, chemical, plasma or ion etching, or some other technique compatible with lithographic processing or laser based microfabrication approaches. The water channel may have an inlet end 14 where the water is introduced to the channel, and an outlet end 18 (FIG. 3), which carries the remaining water away from the 3D-Ti-PTL. The dimensions of the water channel for the anode side may be about 25 microns to about 500 microns, and the water channel may have a depth of about 13 microns to about 125 microns. It should be understood that these dimensions are exemplary only, and the these design details will depend on the requirements of the application.

The water channel may be configured as a serpentine channel as shown, wherein the channel meanders in substantially parallel legs, from side to side, but is a continuous fluid channel, directing water from the inlet end 14 to the outlet end 18. This serpentine path may be characterized by a characteristic axis (FIG. 3), which is defined as the axis parallel to a majority of the legs of the serpentine channel. The serpentine channel provides a fluid channel of substantial length but nonetheless within a confined area. In other words, the serpentine shape can proved a large surface area where the electrolysis can occur. The pitch P1 between the legs of the serpentine may be about 25 microns to about 400 microns. It should be understood that these dimensions are exemplary only, and the these design details will depend on the requirements of the application.

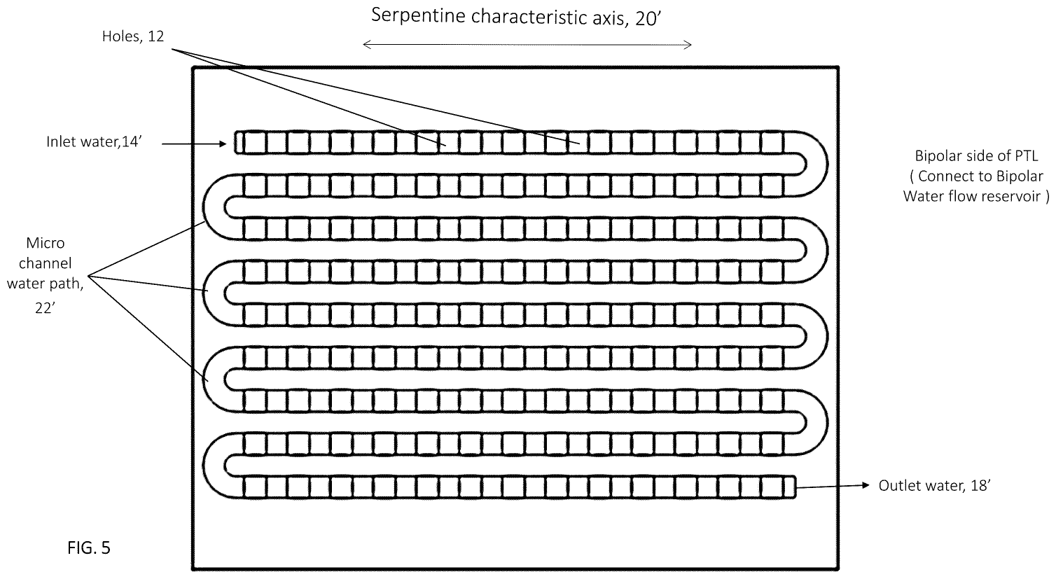

Other features shown in FIG. 2 include a plurality of holes 12, that occur at intervals along the water channel. These holes 12 may extend through the thickness of the Ti substrate, such that fluids (i.e. either water or gaseous materials H2 or O2) may flow freely from the first anode side of the substrate to the other obverse bipolar side. These holes may be formed at locations where the water channel on the anode side crosses over the water channel on the bipolar side. This geometry is described further below with respect to FIG. 5.

The pitch P2 between the holes may be about 75 microns to about 800 microns. The diameter D1 of the holes may be about 25 microns to about 500 microns. It should be understood that these dimensions are exemplary only, and the these design details will depend on the requirements of the application.

FIG. 3 shows a wider field view of the anode side of a microfabricated 3D-Ti-PTL. Included in FIG. 3 is the complete micro channel water path 22, having the input end 14 and the output end 18. FIG. 3 clearly illustrates the definition of the characteristic serpentine axis 20, which is the direction parallel to a majority of the back-and-forth legs of the serpentine. This plan view shows the first face or side of the substrate into which is formed the first water channel.

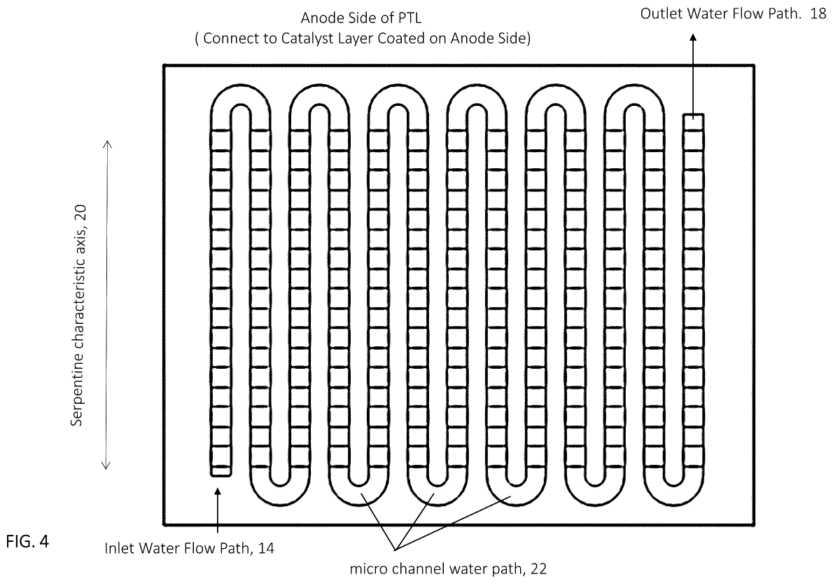

FIG. 4 is a simplified plan view of the anode side of the PTL, showing once again the micro channel water path 22, having an inlet end 14 and an outlet end 18. As with FIG. 3, the plan view clearly illustrates the definition of the characteristic serpentine axis 20, which is the direction parallel to a majority of the back-and-forth legs of the serpentine. This plan view shows the first face or side of the substrate into which is formed the first water channel.

FIG. 5 is a simplified plan view of the second, obverse, Bipolar side of the 3D-Ti-PTL (which is coupled to the bipolar water low reservoir). Reference numbers used in FIG. 5 are all primed (14′ rather than 14) to emphasize that while the second water channel 22′ is similar in ways to the first water channel 22, they are in fact two separate microfabricated structures. In fact the first water channel 22 and other features may be formed lithographically on the first side, the substrate 10 then flipped over, and the second water channel 22′ formed on the obverse, bipolar side. In this sense, this titanium porous transport layer is a three dimensional (“3D”) rather than the two dimensional (“2D”) structure.

Accordingly, as can be seen in FIG. 5, the bipolar side may also have a second water channel 22′ formed therein. This second water channel 22′ may have similar dimensions as first water channel 22, or the structure may be entirely different. In any case, the second water channel 22′ will have locations at which it crosses over the first water channel 22 on the opposite side of the substrate. At these locations, holes 12 may be formed that extend through the entire thickness of the substrate 10.

The two water channels may be regular serpentine shapes as depicted, but this is not necessarily the case. The water channels may have any arbitrary shape, but will have at least one location where the first water channel crosses over (or under) the second water channel. At this location, at least one through hole is formed which allows fluid communicate from the first side to the second obverse side. More generally, the first water channel and the second water channel may have legs that are nonparallel and non-orthogonal, such that these legs overlap in at least one location. If the first water channel and the second water channel are regular serpentine shapes, each characterized by a serpentine characteristic axis, but a non-parallel and non-orthogonal angle exists between these axes, the through holes will appear in a regular array based on that angle between the serpentine characteristic axes.

Referring to the dimensions give for FIG. 5, it is clear that the total length of the first and/or second water channels may have a wide range, but lengths of between about 5 mm to 50 mm are contemplated. The serpentine pattern allows this long channel length and thus ample catalysis surface area, even while maintaining a small foot print or form factor.

Accordingly, described above with respect to FIGS. 2-5 is a three dimensional titanium porous transport layer. These figures illustrate the following points: The current state of the art technology to build PTL is to use sintered titanium powdered to build a mesh-felt structure with thickness of 250 um, these are all 2D structures. Disclosed above is a quite different approach: a 3D Titanium based PTL with following features.
Titanium based 3D Micro Porous Transport Layer (3DTi-PTL) that having a permeability for gaseous and liquid substances in an electrochemical cell
The 3D Ti-PTL may be made of titanium sheets. The thickness of the micro Ti-PTL may be anywhere from 25 um to 250 um.
The proposed 3D Ti-PTL has significant less porosity compared to other existing state-of-the-art PTLs, yet outperforms other existing PTL technologies in the market. The proposed 3DTi-PTL has less porosity compared to other existing state-of-art PTLs, as a result, it provides less ohmic electric resistance for electron to conduct in through plane direction. This means, it provides better performance for the cell because of the reduction of high-frequency resistance (HFR). HFR is the value obtained at high frequencies (usually >1 kHz) and mainly represents the membrane ionic resistance. HFR is a good indicator of the water content of the membrane due to its first component dependency on water. It is commonly used for the state-of-health monitoring of a fuel cell stack and is a critical indicator for dry out (i.e., low water content of the polymer electrolyte) or flooding (i.e., too much water inside fuel cell electrodes) conditions inside the fuel cell stack. HFR is also an important indicator of certain types of degradation in the fuel cell. It affects the performance of the fuel cell, especially at high current densities as it is closely related to the ohmic voltage loss (ΔVohm=I×R).

The proposed 3D-Ti-PTL has less porosity compared to other existing state-of-art PTLs, as a results the proposed PTL provides much higher mechanical rigidity. This means, it enables to reduce the membrane layer thickness (reduce ohmic resistance of membrane layer) or assist to increase the rigidity of the membrane layer (allows to operate in higher pressure difference condition). This is extremely important for manufacturing and assembling of the PEMWE and fuel cells. It reduces the cost of manufacturing while increases the fuel cell overall performance.

The interfacial contact resistance (ICR) between proposed 3D-Ti-PTL and the coated catalysis in anode can be reduced by applying precious group metal (PGM) coatings on the Ti-PTL surfaces. Candidate materials may include gold (Au), Platinum (Pt) palladium (Pd) or other PGMs.

The 3D Ti based micro PTL is made of titanium uses a two dimensional liquid path on both side (Bipolar and Anode sides) to transport the water through the novel PLT. The liquid path can be patterned to increase the kinetic between water and the coated catalyst layer on Anode. As a result, more protons may be produced in PEMWE cells, leading to higher efficiency, lower size and lower cost.

There may be throughout micro holes incorporated to the liquid path pattern to transport the biproduct gaseous components generated at anode in the through-plane direction of the PTL without blocking the water management path (FIG. 1) and the micro fabricated features in PTL allows a conduction path for produced electron to transport through the PTL.

Because the features Illustrated In FIGS. 2-5 are formed photolithographically, the parameter space is easy to explore. The following parameters in FIGS. 2-5 can be changed/optimized to increase the performance of the cell:
The pitch for the micro path pattern (P1) can be changed
The diameter of the holes (D1) can optimized
The pitch between the holes (P2) can be changed
The electron conduction path width can be changed to reduce the ohmic electrical resistance to transport the electron in In the through-plane direction

Exemplary ranges of these parameters preferably include:
The pitch for the micro path pattern (P1) is 25 □m to 400 □m.
The diameter of the holes (D1) is 25 □m to 500 □m.
The pitch between the holes (P2) is 75 □m to 800 □m.
The electron conduction path width is 25 □m to 400 □m
The PTL thickness is 25 □m to 250 □m.
2D water management pattern of the Ti-PTL for anode side shown in FIG. 4 may have a depth of 13 □m to 125 □m and the width of 25 □m to 500 □m.
2D water management pattern of the Ti-PTL for bipolar side shown in FIG. 5 may have a depth of 13 □m to 125 □m and the width of 25 □m to 500 □m.

It should be understood that these dimensions and details are exemplary only.

Accordingly, described here is a titanium substrate porous transport layer for use in a hydrogen polymer electrolytic membrane water electrolysis (PEMWE). The titanium substrate may have two obverse sides, an anode side and a bipolar side, wherein the two obverse sides are separated by a thickness of between about 25 and 250 microns, and wherein the anode side has formed therein a first water channel and bipolar side has formed therein a second water channel, wherein the first and the second water channels are nonparallel and non-orthogonal, and at positions where the first water channel on the first water carrying anode side crosses over the second water channel on the obverse side, at least one through hole Is formed through the titanium substrate, allowing water to flow between the first and the second water carrying channels while also allowing gaseous oxygen to be transferred therethrough.

The first and the second water channel may define a first and a second continuous serpentine water channel, having a first and second characteristic axis defined by each of the first and the second continuous serpentine water channel, wherein the a first and second characteristic axes has an angle therebetween. In some embodiments, the angle between the first and the second characteristic axis may be between 0 and 90, exclusive. The at least one through hole may comprise a plurality of through holes arranged in an array defined by the crossings of the first and the second continuous serpentine water channels.

The first and the second water channel may have a width of about 25 um to 500 um and a depth of about 13 um to 125 um. The at least one hole may have a diameter of about 25 um and 500 um. The first and the second water channels may have a width of between about of 25 □m and about 500 □m, and the depth of about 13 um and about 125 um and the width of 25 um and about 500 um.

The first and second water channels and the at least on hole may define a three dimensional porous transfer layer for a hydrogen fuel cell. The array of holes may have a pitch of between about 75 □m to 800 □m, and the pitch between adjacent legs of the continuous serpentine water channel is between about 25 □m and 400 □m. The first and the second water channels are patterned to increase the kinetic between water and a coated catalyst layer adjacent to the anode side, resulting in an increase of hydrogen protons per fuel cell.

The first and the second water channels may be patterned to transport biproduct gaseous components generated on the anode side in the through-plane direction, without blocking the water channels, and wherein microfabricated features define a ahigh conductivity conduction path for electron to transport through the titanium substrate.

In some embodiments, the continuous serpentine water channels and the plurality of holes may define an electron conduction path having a width of between about 25 □m an 400 □m, In a through-plane direction.

A method is also described, for manufacturing a porous transport layer. The method may include microfabricating a first water channel Into a first side of a titanium substrate, microfabricating a second water channel Into a second obverse side of a titanium substrate, and forming through holes at the location where the first water channel on the first side crosses over the second water channel on the second obverse side.

Microfabricating the first and second water channels may include etching a first and second continuous serpentine water channel, having a first and second characteristic axis defined by each of the first and the second continuous serpentine water channel, wherein the a first and second characteristic axes Is form an angle therebetween. The angle between the first and the second characteristic axis may be between 0 and 90, exclusive. The at least one through hole may comprise a plurality of through holes arranged In an array defined by the crossings of the first and the second continuous serpentine water channels.

Within the method, the first and the second water channel may have a width of about 25 □m to 500 □m and a depth of about 13 □m to 125 □m. Within the method, the at least one hole has a diameter of about 25 □m and 500 □m. Within the method, the first and the second water channels have a width between about of 25 □m and 500 □m, and the depth of about 13 □m and 125 □m and the width of 25 □m and 500 □m.

The method may further include providing a coated catalyst layer adjacent to the anode side, and wherein the first and second water channels are patterned to increase the kinetic between water and a coated catalyst layer adjacent to the anode side, resulting in an increase of hydrogen protons per fuel cell, and wherein the first and second water channels are patterned to transport biproduct gaseous components generated on the anode side in the through-plane direction, without blocking the water channels, and wherein microfabricated features define a ahigh conductivity conduction path for electron to transport through the titanium substrate, and wherein the continuous serpentine water channels and the plurality of holes define an electron conduction path having a width of between about 25 □m an 400 □m, In a through-plane direction.

Further disclosed is a polymer electrolyte membrane water electrolyzer (PEMWE), comprising the titanium substrate described above, a catalyzer layer adjacent to the titanium substrate, wherein the titanium substrate allows transport of reactant water from an anode and cathode, removing produced oxygen gas and providing good electrical conductivity for effective electron conduction.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1) A titanium substrate having two obverse sides, an anode side and a bipolar side, wherein the two obverse sides are separated by a thickness of between about 25 and 250 microns, comprising:
a first water channel formed in the anode side;
a second water channel formed in the bipolar side, wherein the first and the second water channels are nonparallel and non-orthogonal over at least a portion of their extent, and
at least one through hole formed through the titanium substrate, and disposed at positions where the first water channel on the anode side crosses over the second water channel on the obverse bipolar side, allowing water to flow between the first and the second water carrying channels while also allowing gaseous oxygen to be transferred therethrough.

2) The titanium substrate of claim 1, wherein the first and second water channels define first and second continuous serpentine water channels, having a first and second characteristic axis defined by each of the first and the second continuous serpentine water channel, wherein the a first and second characteristic axes is formed an angle therebetween.

3) The titanium substrate of claim 2, wherein the angle between the first and the second characteristic axis Is between 0 and 90, exclusive.

4) The titanium substrate of claim 1, wherein the at least one through hole comprises a plurality of through holes arranged In an array defined by the crossings of the first and the second continuous serpentine water channels.

5) The titanium substrate of claim 1, wherein the first and the second water channel have a width of about 25 um to about 500 um and a depth of about 13 um to about 125 um.

6) The titanium substrate of claim 1, wherein the at least one hole has a diameter of about 25 um and about 500 um.

7) The titanium substrate of claim 1, wherein the first and the second water channels have a width between about 25 um and about 500 um, and the depth of about 13 um and about 125 um and the width of about 25 um and about 500 um.

8) The titanium substrate of claim 1, wherein the first and second water channels and the at least on hole define a three dimensional porous transfer layer for a hydrogen fuel cell.

9) The titanium substrate of claim 4, wherein the array of holes has a pitch of between about 75 um to about 800 um, and the pitch between adjacent legs of the continuous serpentine water channel Is between about 25 um and about 400 um.

10) The titanium substrate of claim 1, wherein the first and second water channels are patterned to increase the kinetic between water and a coated catalyst layer adjacent to the anode side, resulting in an increase of hydrogen protons per fuel cell.

11) The titanium substrate of claim 1, wherein the first and second water channels are patterned to transport biproduct gaseous components generated on the anode side in the through-plane direction, without blocking the water channels, and wherein microfabricated features define a ahigh conductivity conduction path for electron to transport through the titanium substrate.

12) The titanium substrate of claim 4, wherein the continuous serpentine water channels and the plurality of holes define an electron conduction path having a width of between about 25 um and about 400 um, In a through-plane direction.

13) A method for manufacturing a porous transport layer for a hydrogen electrolysis fuel cell, comprising:
microfabricating a first water channel Into a first side of a titanium substrate;
microfabricating a second water channel Into a second obverse side of a titanium substrate; and
forming through holes at the location where the first water channel on the first side crosses over the second water channel on the second obverse side.

14) The method of claim 13, wherein microfabricating the first and second water channels comprises etching a first and second continuous serpentine water channel, having a first and second characteristic axis defined by each of the first and the second continuous serpentine water channel, wherein the a first and second characteristic axes Is form an angle therebetween.

15) The method of claim 14, wherein the angle between the first and the second characteristic axis Is between 0 and 90, exclusive.

16) The method of claim 13, wherein the at least one through hole comprises an plurality of through holes arranged In an array defined by the crossings of the first and the second continuous serpentine water channels.

17) The method of claim 13, wherein the first and the second water channel have a width of about 25 um to 500 um and a depth of about 13 um to about 125 um.

18) The method of claim 13, wherein the at least one hole has a diameter of about 25 um and about 500 um.

19) The method of claim 13, wherein the first and the second water channels have a width between about of 25 um and about 500 um, and the depth of about 13 um and about 125 um and the width of about 25 um and about 500 um.

20) The method of claim 14, further comprising providing a coated catalyst layer adjacent to the anode side, and wherein the first and second water channels are patterned to increase the kinetic between water and a coated catalyst layer adjacent to the anode side, resulting in an increase of hydrogen protons per fuel cell, and wherein the first and second water channels are patterned to transport biproduct gaseous components generated on the anode side in the through-plane direction, without blocking the water channels, and wherein microfabricated features define a ahigh conductivity conduction path for electron to transport through the titanium substrate, and wherein the continuous serpentine water channels and the plurality of holes define an electron conduction path having a width of between about 25 □m an 400 □m, In a through-plane direction.

21) A polymer electrolyte membrane water electrolyzer (PEMWE), comprising:
the titanium substrate of claim 1,
a catalyzer layer adjacent to the titanium substrate, wherein the titanium substrate allows transport of reactant water from an anode and cathode, removing produced oxygen gas and providing good electrical conductivity for effective electron conduction.
